(19) United States
(12) Patent Application Publication
(10) Pub. No.: US 2020/0274834 A1
(43) Pub. Date: Aug. 27, 2020

(54) METHODS AND SYSTEMS TO FACILITATE DISCOVERY OF RELEVANT OUTSIDE COUNSEL

(71) Applicant: Darren VanPuymbrouck, Chicago, IL (US)

(72) Inventor: Darren VanPuymbrouck, Chicago, IL (US)

(21) Appl. No.: 16/794,021

(22) Filed: Feb. 18, 2020

Related U.S. Application Data
(60) Provisional application No. 62/810,865, filed on Feb. 26, 2019.

(51) Int. Cl. H04L 12/58; G06F 16/9035; G06F 21/62; G06Q 50/18

(52) U.S. Cl. CPC H04L 51/046; G06Q 50/18; G06F 21/6245; G06F 16/9035

(57) ABSTRACT

Systems and methods to enable anonymous attainment of counsel are disclosed. A corporate computing device (“CCD”) is associated with a corporate entity (“CE”). A plurality of information stores each comprise a legal data point(s). A control circuit is communicatively coupled to the plurality of information stores and configured to: receive, via the CCD, a legal issue associated with the CE; determine whether each legal data point is associated with the legal issue; identify an outside counsel associated with the legal data point; determine if the counselor desires to participate in a social communication with an anonymous CE; convey the legal issue to the outside counsel when the outside counsel desires to participate in the social communication; receive a comment about the legal issue from the outside counsel; establish a communications link between the counselor and the CE; and convey the CE to the outside counsel anonymously via the communications link.

### CROSS-REFERENCE TO RELATED APPLICATIONS

This application claims priority to U.S. Provisional Application No. 62/810,865 filed Feb. 26, 2019, which is hereby incorporated herein by reference.

### FIELD OF THE INVENTION

The present invention relates generally to a field of data processing. More specifically, the present invention relates to methods and systems to facilitate discovery of and engagement with outside counsel.

### BACKGROUND OF THE INVENTION

An important legal issue for U.S. companies is the reduction of their $270 billion spend on outside legal counsel, 40% of which they report is portable. Despite decades of attempts to rein in their legal spending, the percentage of company profits spent on outside counsel continues to soar. Many issues persist in preventing companies from realizing a reduction in the growth of their legal spend, much less a true reduction, including companies' inability to identify relevant outside counsel and the price at which the services of such lawyers can be retained. In addition, many companies are leanly staffed and have inadequate funding or time to conduct adequate searches for relevant outside counsel, particularly under the pressures of impending legal matters. Left to rely on networks and word-of-mouth recommendations, companies of all sizes retain attorneys based on representations and referrals and not on empirical data.

At the same time, outside lawyers and law firms spend billions marketing their services to companies with little proof of the effectiveness of such efforts. Many lawyers with relevant expertise are never made known to companies with need for their services for many reasons including the structure of law firms, the lack of data readily available to companies about lawyers, and the distortions caused by self-promoting attorneys.

Therefore, there is a need for improved methods and systems to facilitate companies to discover relevant outside counsels for retention on specific matters that may overcome one or more of the above-mentioned problems and/or limitations.

### BRIEF DESCRIPTION OF THE DRAWINGS

The accompanying drawings, which are incorporated in and constitute a part of this disclosure, illustrate various embodiments of the present disclosure.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a system to enable anonymous attainment of counsel consistent with various embodiments of the present disclosure.

FIG. 2 is a flowchart of a method to enable anonymous attainment of counsel, in accordance with some embodiments.

FIG. 3 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

As used herein, the term “outside counsel” refers to an attorney or attorneys that are not employed by the United States federal government nor counsel to an agency of the State. Further, “in-house counsel” are officers and employees of companies who retain and supervise outside counsel who are hired to represent a company in a wide range of legal matters, including, but not limited to, policy, tax, regulatory matters etc. associated with a corporate entity. As used herein, the term “in-house counsel” refers to an attorney or attorneys that are employed fulltime by a non-governmental corporation, partnership, association, or other legal entity, including its subsidiaries and organizational affiliates, that is not itself engaged in the practice of law or the rendering of legal services outside such organization. The present disclosure includes many aspects and features. Moreover, while many aspects and features relate to, and are described in the context of methods and systems to facilitate companies to discover relevant outside counsels for retention on specific matters, embodiments of the present disclosure are not limited to use only in this context.

Overview:

The present disclosure provides methods and systems to facilitate companies to discover relevant outside counsels for retention on specific pending matters (such as legal issues of a company/firm).

The global spend on outside legal representation by corporations each year exceeds $700 Billion, $270 Billion in the U.S. alone. Corporate legal department, CEOs, CFO's and business owners are under enormous pressure to reduce such expenditures. Four significant issues thwart efforts to reduce the cost of outside legal services: (1) the inability of companies to identify accurately outside counsel with relevant expertise; (2) the inability of companies to discern the true cost at which such services can be purchased; (3) the lack of time and resources available to companies to adequately investigate, contact, and negotiate the retention of relevant outside counsel; and (4) the lack of a technology-driven service to provide companies with data to quickly identify relevant lawyers and a platform to allow companies to negotiate with multiple outside lawyers with relevant expertise to retain the best-in-class lawyers at the best-in-class prices.

At the same time, outside legal providers in the U.S. spend an estimated $6 Billion on legal marketing and sales of their services to companies annually, often with little, if any, return on their investment. The efforts of outside lawyers to be recognized and retained for matters within their relevant expertise is thwarted by three significant issue: (1) the law firm structure that rewards rain-makers who lack relevant expertise but who control client relationships and dictate which lawyers performs the client's work; (2) the share number and geographic diversity of outside counsel and their nuanced areas of expertise; and (3) companies' reliance on antiquated word-of-mouth referrals for retaining outside counsel that tends to lack diversity and concentrates work in established networks not based on true expertise.

The instant disclosure seeks to provide methods and associated systems specifically designed to break through this standoff by providing an on-line, interactive platform for companies to request and vet information about outside lawyers with expertise relevant to the companies' specific legal needs. The method aggregates data from the public record identifying the experience, performance, and cost of outside counsel to respond to companies' requests for information (“RFI”) tailored to the specific legal need at issue. Importantly, only those outside lawyers with relevant expertise as demonstrated by the public record to respond to companies' RFIs are invited and lawyers who have not been identified from the public record are not invited to “join” its platform or to respond to company RFIs. Embodiments of the instant disclosure severely curtail outside lawyers' self-promotion and removes ambiguities about lawyers' experience and expertise so that companies can retain counsel on their merits alone. Embodiments of the instant disclosure greatly increase the scope of companies' search for relevant outside counsel while dramatically reducing the time required to do so and provides companies the ability to anonymously negotiating rates 50-100% lower than they regularly pay for the legal services required to meet their companies' legal needs.

Unlike other solutions known in the art that purport to have pre-populated networks of chosen law firms, embodiments of the instant disclosure conduct a multi-faceted approach to identify relevant lawyers customized to the specific request for information posted by its customers. The many techniques employed in this process include electronically scrapping of law firm websites, on-line court dockets, conferences brochures at which outside counsel present on areas of their expertise, public listings of settled claims and lawsuits, announcements of corporate mergers and acquisitions, and federal and state agencies' websites and databases. This allows embodiments of the instant disclosure to identify the individual lawyers, not law firms, who are most relevant to the legal matters for which companies seek representation.

The price for legal services charged by outside counsel to companies is one of the most oblique aspects of the legal industry. Although law firms maintain and annually update billing rates for all of their time keepers, those “rate sheets” are not provided to clients much less prospective clients or made public and generally consist of multiple rates for each time keeper so that lawyers and law firms are free to charge clients the highest rate possible while remaining within the confines of their rate schedules. Embodiments of the instant disclosure allow companies to simultaneously compare and negotiate the rates charged by multiple outside counsel with similar experience and expertise thereby allowing companies to accurately gauge the true cost for such services and to negotiate the best price allowing them to reduce their legal spend by 50-100%. Should they choose to do so, embodiments of the instant disclosure allow companies to conduct such negotiations anonymously while controlling the length of responses so that the time to vet outside counsel can be limited. Embodiments of the instant disclosure also allow various officers and employees within a company to collaborate with their colleagues by allowing multiple users from the same company to review the responses of outside counsel.

Embodiments disclosed herein seek to provide an online, interactive platform for in-house corporate counsel to anonymously post requests for information and receive responses from relevant outside attorneys. Further, embodiments disclosed herein seek to increase the scope of in-house counsel's search for relevant outside counsel while reducing the time required to conduct such searches and provide in-house counsel with anonymity while negotiating rates that are 50% lower than can be achieved through existing methods of hire outside lawyers.

Prior solutions known in the art utilize pre-populated networks of chosen law firms that involve lawyers and law firms identifying their claimed areas of legal expertise rather as might be identified through publicly available data. The instant disclosure, for example, can conduct a multi-faceted approach to identify relevant lawyers customized to a particular information request. Further, applicable techniques include, but are not limited to, data scraping (i.e. the extraction of data from human-readable output coming from another program) of law firm websites, online court dockets, brochures for conferences at which outside counsel present on areas of their expertise, public listings of settled claims and lawsuits, announcements of corporate mergers and acquisitions, as well as federal and state agencies' websites and databases. Further, the many techniques employed in the process, in an instance, may allow one to identify outside counsel (e.g., individual lawyers, solo practitioners, as well as law firms) who may be relevant to the legal matter(s) of interest to in-house counsel.

Certain embodiments of the instant disclosure allow in-house counsel to anonymously communicate with outside counsel via an online platform (hereinafter “platform”) while controlling response length to thereby limit vetting time. Other embodiments seek to allow in-house counsel to compare and/or negotiate rates charged by outside counsel, which can thereby reduce a company's legal spend by 50-100%. Further, certain embodiments seek to allow in-house counsel to collaborate with their colleagues via the platform by allowing multiple users from the same company to review the responses of outside counsel.

Further, in-house counsel may register on the platform via the Internet. In-house counsel identification may be verified. Upon successful verification of in-house counsel, an anonymous identification for the in-house counsel's company can be generated. Identification of the corporate entity associated with in-house counsel can be posted on the platform using anonymous identifications. Further, the accuracy of the identification of the company may be verified. In some embodiments, one or more legal issues of interest to in-house counsel are posted on the platform as well as, for example, associated questions or comments generated by in-house counsel. Here, outside counsel can post responses to the legal issue(s), questions, and/or comments posted by in-house counsel.

In certain embodiments, a comprehensive search for relevant legal information associated with the in-house counsel is conducted, for example, using information provided by outside counsel. For example, comprehensive searches can include, but are not limited to, computer algorithms, data scrapping programs, and/or word identification analysis of reported cases, law journals, conference brochures, published speeches, governmental websites, periodical, law firm websites, bar journal publications, reports on settlements and verdicts, reports of corporate transactions, bankruptcy reports, as well as similar information.

Further, identified outside counsel may be contacted regarding the platform and its customer's interest in participating in a social communication with outside counsel to, for example, vet relevant outside counsel. As used herein, “social communication” refers to the use of language in a social context. In-house counsel and outside counsel utilize social communications to convey their positions and comprehend those of others. Outside counsel can register their information on the platform. For example, the credentials of outside counsel can be verified. In preferred embodiments, outside counsel transmits responses to the legal issue(s), questions, and/or comments posted by in-house counsel.

In some embodiments, the responses of outside counsel are limited by character (e.g., a 200-character limit) to control the amount of time required for in-house counsel to vet and select counsel. In some aspects, outside counsel are rejected via an anonymous function option on the platform. Outside counsel can upload one or more responses to legal issues of interest, questions, and/or comments posted by in-house counsel. In certain embodiments, outside counsel and in-house counsel can communicate anonymously in real-time. For example, in-house counsel can request to meet with outside counsel. In some embodiments, contact information between the in-house counsel and the outside counsel is automatically exchanged, for example, in response to in-house counsel selection of the outside counsel.

Further, the platform, in an instance, may facilitate meetings between the in-house counsel and the outside counsel in person or electronically (e.g., in real-time). Further, in an embodiment, negotiations and agreements between the in-house counsel and the outside counsel over, for example, the scope of representation and the fees to be charged for the same are facilitated.

To be sure, embodiments disclosed herein utilize a network (e.g., the Internet) to facilitate communication between in-house counsel and outside counsel. Embodiments disclosed herein may take the form a web page or app generated using a markup language (e.g., HTML), a style sheet language (e.g., CSS), and/or other programming language.

Further, in-house counsel may review and comment on responses from outside counsel, in accordance with preferred embodiments. In other embodiments, responses and comments are accessible with colleagues of the in-house counsel. Further, search results can be stored (e.g., in a self-referential table) for subsequent review and/or future usage by the in-house counsel. Further, a search engine for identifying relevant outside attorneys, in an instance, may be constructed using the Hypertext Transfer Protocol. Further, the scraping (web-scraping) may be an automated process using a web crawler to mine and/or copy specific data from the web about relevant outside attorneys. Further, information (such as the specific data), in an instance, may be deposited into a central local database.

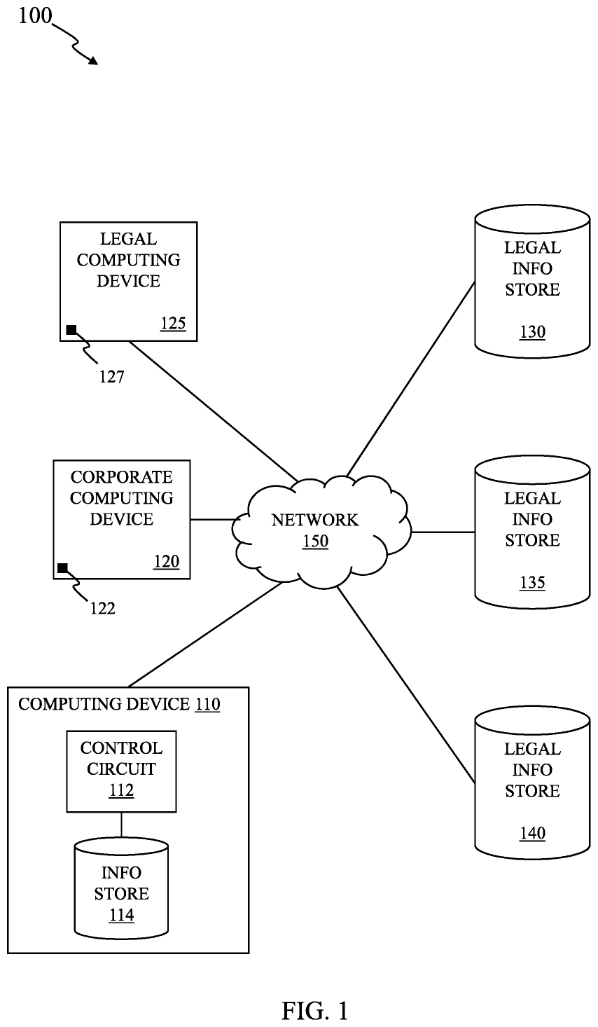

FIG. 1 illustrates an environment, generally 100, to enable anonymous attainment of counsel consistent with various embodiments of the present disclosure. Here, environment 100 includes one or more a computing device 110, a corporate computing device 120, a legal computing device 125, a legal info store 130, a legal info store 135, and a legal info store 140 all in communication via network 150. Network 150 can be, for example, a local area network (“LAN”), a wide area network (“WAN”), such as the internet, a distributed computing environment, cluster computing environment, or a combination of two or more thereof, and can include wired, wireless, or fiber optic connections. Network 150 can be compatible with a variety of communications protocols, such as those associated with Bluetooth, Wi-Fi, LTE, cellular, radio, microwave, as well as other wireless communication protocols. In general, network 150 can be any combination of connections and protocols that will support communications between the computing device 110, the corporate computing devices 120, the legal computing device 125, the legal info store 130, the legal info store 135, and the legal info store 140.

In preferred embodiments, computing device 110, corporate computing device 120 and/or legal computing device 125 can each include one or more computing devices, personal computers, wearable computing devices, distributed computing systems, tablet computers, smartphones, smart home devices, internet-of-things (“IOT”) computing devices, or any electronic devices that can communicate with network 150 to enable one or more embodiments disclosed herein. Corporate computing device 120 and legal computing device 125 can include user interface 122 and user interface 127, respectively. The user interface 122 and user interface 127 can be associated with a mobile app and/or a website utilized to transmit information about the corporate counsel/entity and outside counsel, respectively.

Each corporate computing device 120 is preferably associated with at least one in-house counsel employed by a corporate entity (e.g., General Counsel to ABC Corp.). In other words, in-house counsel uses the corporate computing device 120 to communicate with the computing device 110 and outside counsel via the legal computing device 125. Payments can be received and/or transmitted using the corporate computing device 120. Invoices can be received and/or transmitted via the corporate computing device 120. In certain embodiments, invoices of the instant disclosure do not include information protected by the attorney-client privilege and/or attorney work product.

Each legal computing device 125 is preferably associated with one or more outside counsel employed by a law firm (e.g., John Doe, Esq. at ABC Law Firm LLC.). In other words, outside counsel uses the legal computing device 125 to communicate with the computing device 110 and in-house counsel via the corporate computing device 120. Payments can be received and/or transmitted via the legal computing device 125. In some embodiments, outside counsel uses the legal computing device 125 to submit proof of their objective expertise.

In other embodiments, legal information stores 130, 135, and/or 140 can include one or more storage devices that may be used for storing, porting and/or extracting data files and objects. For example, legal info stores 130, 135, and/or 140 may store information temporarily and permanently. The legal info stores 130, 135, and/or 140 can be positioned internal or external to a computer, server or any similar computing devices. According to preferred embodiments, legal info stores 130, 135, and/or 140 may include information associated with reported cases, law journals, conference brochures, published speeches, governmental websites, periodical, law firm websites, bar journal publications, reports on settlements and verdicts, reports on corporate transactions, bankruptcy reports, general information concerning adjudications, as well as similar information (hereinafter “legal data points”). In general, the legal info stores 130, 135, and/or 140 can include any information associated with adjudications, government policy, state and/or federal codes and regulations, and similar legal information

Further, the legal info stores 130, 135, and/or 140, in an instance, may include, but are not limited to, case law, state and federal statutes, administrative codes, newspaper and magazine articles, public records, law journals, law reviews, treatises, legal forms and/or other information resources.

According to preferred embodiments of computing device 110 may comprise at least one control circuit 112 communicatively coupled to at least one information (“info”) store 114. For example, control circuit 112 can perform one or more of processes, methods, and/or steps disclosed herein. Aspects of info store 114 can refer to at least one information storage device used for storing, porting and/or extracting data files and objects. In other aspects, info store 114 can be an external storage device communicatively coupled to network 150. In certain embodiments, info store 114 includes downloadable versions of user interfaces (“UI”) 122 and 127, which may include one or more predetermined visualization schemes, formatting schemes, language protocols, graphical user interface items, or a combination of two or more thereof. The info store 114 can include registration information associated with the corporate entity (e.g., the corporate computing device 120) and outside counsel as well as search results and past queries. Corporate computing device 120, according to preferred embodiments, is associated with a corporate entity. In preferred embodiments, a plurality of information stores (e.g., the legal info stores 130, 135, and 140) each include one or more legal data points.

The info store 114 can include user data. For example, “user data” as used herein refers to information associated with the in-house counsel. Accordingly, the user data, in an instance, may include characteristics and/or features thereof that may be used to determine an identity associated with the in-house counsel. For instance, the user data may include information such as a personal detail of the in-house counsel, which may include, but not limited to, name, age, email, current location, contact number, national identification number, occupational details, nationality etc. associated with the in-house counsel. Further, in some embodiments, the user data may include sensory data received from one or more sensors that may be embedded within the corporate computing device 120. For instance, the user data may include biometric variables (such as, but not limited to, fingerprint, palm veins, palm print, face, DNA, hand geometry, iris, retina, voice, odor/scent etc.) associated with the in-house counsel. Applicable sensors include, but are not limited to, light sensors, ultrasonic sensors, audio sensors, camera sensors, pressure sensors etc. that may be embedded within or communicatively coupled to the legal computing device 125.

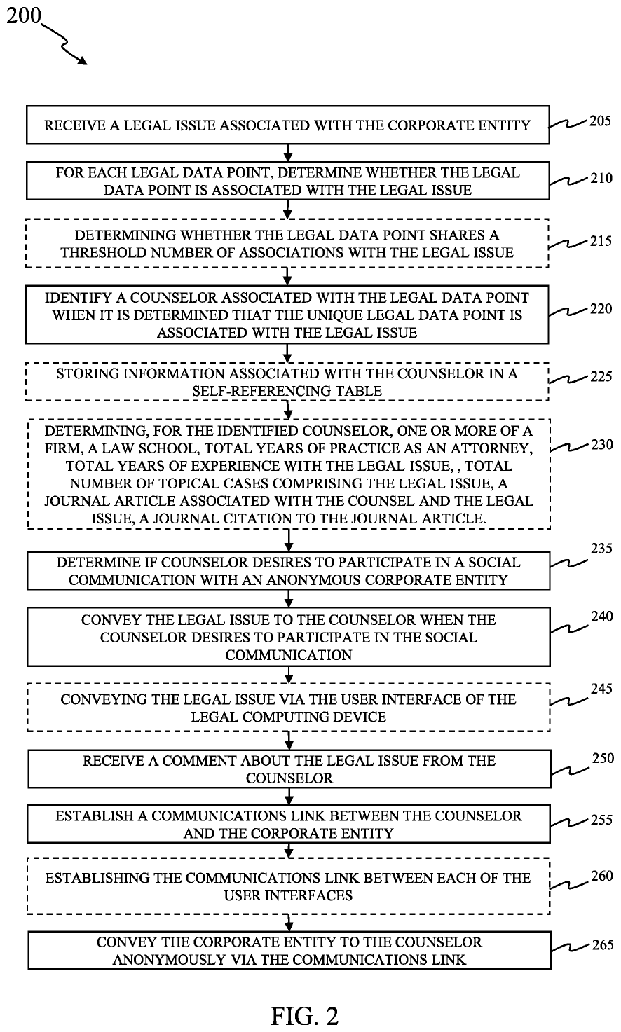

FIG. 2 is a flowchart of a method to enable anonymous attainment of counsel, in accordance with some embodiments. As discussed above, the control circuit 112 is preferably configured to perform one or more steps of the methods disclosed herein. To perform one or more of the steps, processes, functions disclosed herein, the control circuit 112 can one or more data analysis techniques. Applicable data analysis techniques include, but are not limited to, web-scraping, data extraction (e.g. numerical value extraction, format conversion etc.), data analysis (e.g. statistical analysis etc.), image analysis (e.g. OCR, object recognition, face recognition etc.), audio analysis (e.g. speech recognition, speaker recognition etc.) and similar methods. One or more legal issues associated with the corporate entity are received via the corporate computing device 120 (Step 205). As used herein, the term “legal issue” refers to an issue of law, a legal question, or a legal point disputed by parties to a lawsuit. For example, computing device 110 receives one or more legal issues from corporate computing device 120 via the UI 122. In some embodiments, the user data associated with the in-house counsel can be verified by comparing the user data with one or more user information stored in one or more reliable databases (e.g., public and/or private databases, government databases, company databases, college/school databases, databases associated with the corporate entity, etc.).

Further, according to certain embodiments, an anonymous profile associated with the in-house counsel based on the verification can be generated. Accordingly, the anonymous profile, in an instance, may be a user profile that may allow the in-house counsel to anonymously post queries (such as questions), via the UI 127, associated with legal issue(s) to obtain assistance from outside attorneys. Anonymous user profiles can be stored in the info store 114. To be sure, the legal issue may or may not require adjudication. Hence, the corporate entity may desire further understanding of the legal issue for a non-adjudicative purpose.

For each legal data point, whether the legal data point is associated with the legal issue is determined (Step 210). To be sure, Step 210 entails the use of one or more data analysis techniques. In certain embodiments, determination of whether the legal data point is associated with the legal issue includes determining whether the legal data point shares a threshold number of associations with the legal issue (Step 215). At Step 215, data analysis method is preferably performed on the legal data point to determine whether the legal data point shares the threshold number of associations with the legal issue

For example, applicable associations include, but are not limited to, legal issues, legal principles, jurisdiction, holdings, facts, and similar case variables. To be sure, the threshold number of associations is a dynamic value that changes according to the legal issues at play and/or the corporate entity associated with the corporate computing device 120 (i.e. in-house counsel). One or more counselors (i.e. outside counsel) associated with the legal data point are identified when the unique legal data point is determined to be associated with the legal issue (Step 220). Step 220 preferably utilizes one or more data analysis techniques to identify outside counsel associated with the legal data point.

In yet still other embodiments, identifying the outside counsel associated with the legal data point includes storing information associated with the outside counsel in a self-referential table (Step 225). As used herein, the term “self-referential table” refers to a logical model that includes all data entries in a single table, with column definitions provided by rows in that same table. In other words, when storing multiple types of entities (objects) in a database, instead of creating a separate table for each entity and its attributes, the self-referential table allows for storage of all the entities in a single table, while each attribute can be defined by the same table as an entity itself. Here, the self-referential table allows for faster searching of data compared to that provided by the prior art as well as allows for more effective storage of data other than structured text, such as images and unstructured text. Even more, the self-referential model can be launched without extensive modeling and configuration of tables and relationships, and instead can be configured on-the-fly.

In other embodiments, identifying the one or more outside counsel associated with the legal data point includes determining, for the identified outside counsel, a law firm, law school, total years of practice as an attorney, total years of experience with the legal issue (Step 230). Step 230 preferably utilizes one or more data analysis techniques to perform the determination. For example, if the legal data point is a journal article, the author can be identified. In the same vein, if the legal data point is an adjudication, the associated law firm and/or attorneys can be identified. At Step 235, whether the counselor desires to participate in a social communication with an anonymous corporate entity is determined. For example, computing device 110 can transmit a query to the UI 127 inquiring whether the outside counsel associated with legal computing device 125 desires to participate in a social communication with an anonymous corporate entity. The legal issue is conveyed to the counselor when it is determined that the counselor desires to participate in the social communication (Step 240). In other embodiments, conveying the legal issue to the counselor includes conveying the legal issue via the UI 127 of the legal computing device 125 (Step 245). For example, the computing device 110 transmit the legal issue(s) to the UI 127 when it is determined that the outside counsel desires to participate in the social communication.

One or more comments about the legal issue are received from the outside counsel (Step 250). The outside counsel, for example, can use the UI 127 to generate and transmit comments to the computing device 110. A communications link between the counselor and the corporate entity is established when it is determined that the corporate entity desires to participate in the social communication (Step 255). In other embodiments, establishing the communications link between the outside counsel and the corporate entity includes establishing the communications link between each of the user interfaces (Step 260). For example, the network 150 is utilized to establish the communications link between the outside counsel (i.e. the legal computing device 125) and the corporate entity (i.e. the corporate computing device 120).

The corporate entity is conveyed to the outside counsel anonymously via the communications link (Step 265). For example, to reduce human misjudgment (e.g., misconstruing past correlations as a reliable basis for decision making) the identification of the corporate entity associated with the corporate computing device 120 is not presented to the outside counsel via the UI 127.

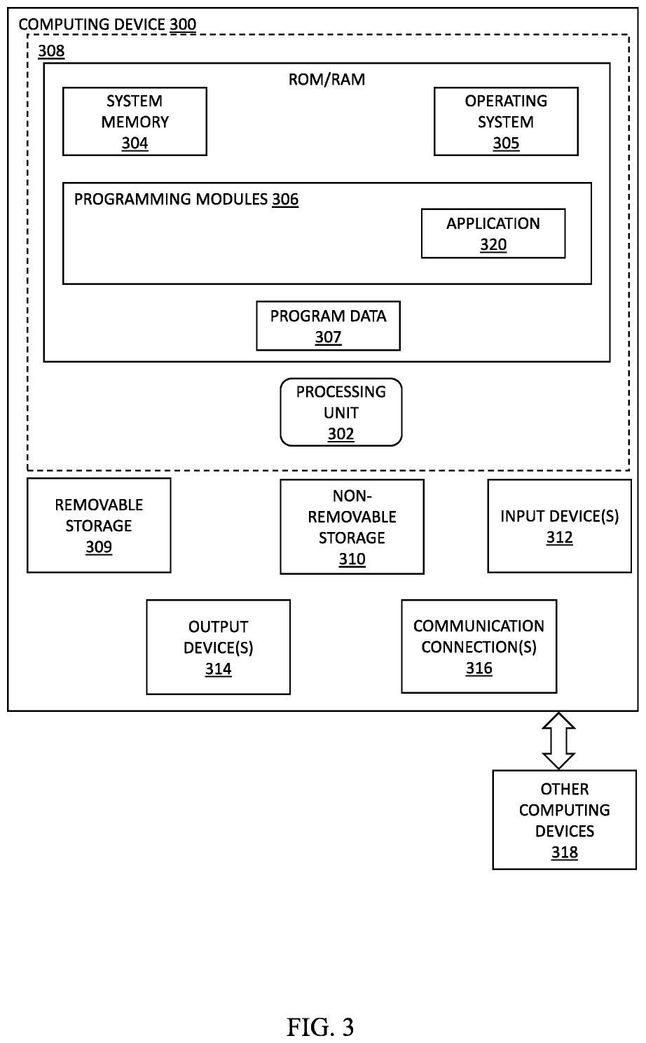

With reference to FIG. 3, a system consistent with an embodiment of the disclosure may include a computing device or cloud service, such as computing device 300. For example, the computing device 300 can represent the computing device 110, the corporate computing device 120, and/or the legal computing device 125. In a basic configuration, computing device 300 may include at least one processing unit 302 and a system memory 304. Depending on the configuration and type of computing device, system memory 304 may comprise, but is not limited to, volatile (e.g. random-access memory (RAM)), non-volatile (e.g. read-only memory (ROM)), flash memory, or any combination. System memory 304 may include operating system 305, one or more programming modules 306, and may include a program data 307. Operating system 305, for example, may be suitable for controlling computing device 300's operation. In one embodiment, programming modules 306 may include image-processing module, machine learning module and/or image classifying module. Furthermore, embodiments of the disclosure may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. For example, the removable storage 309 and the non-removable storage 310 can further represent the legal info store 130, the legal info store 135, and/or the legal info store 140. Computer storage media may include volatile and nonvolatile, removable and non-removable media implemented in any method or technology for storage of information, such as computer-readable instructions, data structures, program modules, or other data. System memory 304, removable storage 309, and non-removable storage 310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, a location sensor, a camera, a biometric sensor, etc. Output device(s) 314 such as a display, speakers, a printer, etc. may also be included. The aforementioned devices are examples and others may be used.

Computing device 300 may also contain a communication connection 316 that may allow device 300 to communicate with other computing devices 318, such as over a network (e.g., the network 150) in a distributed computing environment, for example, an intranet or the Internet. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306 (e.g., application 320 such as a media player) may perform processes including, for example, one or more stages of methods, algorithms, systems, applications, servers, databases as described above. The aforementioned process is an example, and processing unit 302 may perform other processes. Other programming modules that may be used in accordance with embodiments of the present disclosure may include sound encoding/decoding applications, machine learning application, acoustic classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

1. A system to enable anonymous attainment of counsel, comprising:
a corporate computing device associated with a corporate entity;
a plurality of information stores each comprising a legal data point;
a control circuit communicatively coupled to the plurality of information stores;
wherein the control circuitry is configured to:
receive, via the corporate computing device, a legal issue associated with the corporate entity;
for each legal data point, determine whether the legal data point is associated with the legal issue;
identify a counselor associated with the legal data point when it is determined that the unique legal data point is associated with the legal issue;
determine if counselor desires to participate in a social communication with an anonymous corporate entity;
convey the legal issue to the counselor when it is determined that the counselor desires to participate in the social communication;
receive a comment about the legal issue from the counselor;
establish a communications link between the counselor and the corporate entity, when it is determined that the corporate entity desires to participate in the social communication; and
convey the corporate entity to the counselor anonymously via the communications link.

2. The system of claim 1, wherein determining whether the legal data point is associated with the legal issue comprises determining whether the legal data point shares a threshold number of associations with the legal issue.

3. The system of claim 2, wherein identifying the outside counsel associated with the legal data point comprises determining, for the identified outside counsel, one or more of a firm, a law school, total years of practice as an attorney, total years of experience with the legal issue.

4. The system of claim 3, wherein the social communication comprises one or more of a text message, audio, and video.

5. The system of claim 4, further comprising a legal computing device associated with the outside counsel and communicatively coupled to the control circuit;
wherein
the corporate computing device and the legal computing device each comprise a user interface; and
establishing the communications link between the counselor and the corporate entity comprises establishing the communications link between each of the user interfaces.

6. The system of claim 5, wherein conveying the legal issue to the outside counsel comprises conveying the legal issue via the user interface of the legal computing device.

7. The system of claim 6, wherein identifying the outside counsel associated with the legal data point comprises storing information associated with the counselor in a self-referential table.

8. A method to enable anonymous attainment of counsel, comprising:
receiving, via a computing device, a legal issue associated with a corporate entity, the corporate entity associated with a corporate computing device;
determining, via the computing device, whether a legal data point included in a plurality of information stores is associated with the legal issue;
identifying, via the computing device, an outside counsel associated with the legal data point when it is determined that the legal data point is associated with the legal issue;
determining, via the computing device, if the outside counsel desires to participate in a social communication with an anonymous corporate entity;
conveying, via the computing device, the legal issue to the counselor when it is determined that the outside counsel desires to participate in the social communication;
receiving, via the computing device, a comment about the legal issue from the outside counsel
establishing, via the computing device, a communications link between the outside counsel and the corporate entity when it is determined that the corporate entity desires to participate in the social communication; and
conveying, via the computing device, the corporate entity to the counselor anonymously via the communications link.

9. The system of claim 8, wherein determining whether the legal data point is associated with the legal issue comprises determining, via the computing device, whether the legal data point comprises a threshold number of associations with the legal issue.

10. The system of claim 9, wherein identifying the outside counsel associated with the legal data point comprises determining, via the computing device, a qualifications data point associated with the counselor, the qualifications data point comprising one or more of a law firm, a law school, a total number of years as a practicing attorney, a total number of years of topical experience with the legal issue, a total number of topical cases comprising the legal issue, a journal article associated with the outside counsel and the legal issue, a journal citation to the journal article.

11. The system of claim 10, wherein the social communication comprises one or more of a text message, audio, and video.

12. The system of claim 11, wherein
the method further comprises transmitting, via the computing device, a user interface to both the corporate computing device and a legal computing device, the legal computing device associated with the outside counsel; and
establishing the communications link comprises establishing, via the computing device, the communications link between each of the user interfaces.

13. The system of claim 12, wherein conveying the legal issue comprises conveying, via the computing device, the legal issue via the user interface of the legal computing device.

14. The system of claim 13, wherein identifying the outside counsel comprises storing, via the computing device, information associated with the counselor in a self-referencing table.

15. A system to enable anonymous attainment of outside counsel, comprising:
a corporate computing device associated with a corporate entity;
a plurality of information stores each comprising a legal data point;
a control circuit communicatively coupled to the plurality of information stores;
wherein the control circuitry is configured to:
receive, via the corporate computing device, a legal issue associated with the corporate entity;
for each legal data point, determine whether the legal data point is associated with the legal issue;
identify a counselor associated with the legal data point when it is determined that the unique legal data point is associated with the legal issue;
determine if outside counsel desires to participate in a social communication with an anonymous corporate entity;
convey the legal issue to the outside counsel when it is determined that the outside counsel desires to participate in the social communication;
receive a comment about the legal issue from the outside counsel
establish a communications link between the counselor and the corporate entity, when it is determined that the corporate entity desires to participate in the social communication;
convey the corporate entity to the counselor anonymously via the communications link; and
wherein determining whether the legal data point is associated with the legal issue comprises determining whether the legal data point shares a threshold number of associations with the legal issue.

16. The system of claim 15, wherein identifying the counselor associated with the legal data point comprises determining, for the identified counselor, one or more of a firm, a law school, total years of practice as an attorney, total years of experience with the legal issue.

17. The system of claim 16, wherein the social communication comprises one or more of a text message, audio, and video.

18. The system of claim 17, further comprising a legal computing device associated with the counselor and communicatively coupled to the control circuit;
wherein
the corporate computing device and the legal computing device each comprise a user interface; and
establishing the communications link between the outside counsel and the corporate entity comprises establishing the communications link between each of the user interfaces.

19. The system of claim 18, wherein conveying the legal issue to the outside counsel comprises conveying the legal issue via the user interface of the legal computing device.

20. The system of claim 19, wherein identifying the outside counsel associated with the legal data point comprises storing information associated with the outside counsel in a self-referential table.
